(19) United States
(12) Patent Application Publication
(10) Pub. No.: US 2026/0009521 A1
(43) Pub. Date: Jan. 8, 2026

(54) LIGHTING DEVICE AND LIGHT CONVERSION UNIT FOR EMITTING LIGHT IN THE NIR RANGE

(71) Applicant: Schott AG, Mainz (DE)

(72) Inventor: Albrecht Seidl, Mainz (DE)

(73) Assignee: Schott AG, Mainz (DE)

(21) Appl. No.: 19/262,449

(22) Filed: Jul. 8, 2025

(30) Foreign Application Priority Data
Jul. 8, 2024 (DE) 10 2024 119 336.0

(51) Int. Cl. F21V 9/32; F21V 3/04; F21V 29/70

(52) U.S. Cl. CPC F21V 9/32; F21V 3/049; F21V 29/70

(57) ABSTRACT

A lighting device includes a light source for emitting primary light, which is configured as a laser; and a light conversion unit including a light conversion element having at least one light-converting ceramic material, a front side, and a back side, a substrate which is directly or indirectly connected to the back side of the light conversion element, and a connector between the light conversion element and the substrate. The light conversion element is adapted to be illuminated with the primary light and to emit secondary light with a wavelength or wavelength range altered relative to the primary light. The primary light has a wavelength of less than 650 nm and the secondary light has a maximum intensity of emission at a wavelength of more than 650 nm.

### CROSS REFERENCE TO RELATED APPLICATIONS

This application claims priority to German Patent Application No. 10 2024 119 336.0 filed on Jul. 8, 2024, which is incorporated in its entirety herein by reference.

### BACKGROUND OF THE INVENTION

### 1. Field of the Invention

The invention relates to a light conversion unit and to a lighting device with a light source for emitting primary light and with a light conversion unit for emitting secondary light with a wavelength in the (far-) red and NIR range, and to their use.

### 2. Description of the Related Art

Light sources which utilize light-converting materials that convert primary light into light with a wavelength in the range of more than 650 nm are known. They include a multiplicity of known light-converting materials which contain, for example, Cr³⁺, Nd³⁺ and Er³⁺ as phosphorescent ions in various host lattices, especially in host lattices with a garnet structure, for use in light-converting LEDs.

In such lighting devices, the light-converting materials are excited with a primary light, and a primary light spot is formed on the surface of the light-converting material. The irradiated primary light is at least partly converted into secondary light with an altered wavelength and emitted, and a so-called secondary light spot is formed on the surface of the converting material, this spot being naturally always larger than the primary light spot.

Thus U.S. Pat. No. 11,578,267 B2 gives a general description of such light sources using, for example, Cr-doped, NIR-emitting phosphors in combination with further phosphors, principally emitting in the visible spectrum. Such combinations of different phosphors in the form of phosphor powders incorporated in silicone are often used in LEDs and enable very broadband emission spectra by superimposition.

European Patent No. EP 3523830 B1 also describes such a combination of different phosphors for the visible and for the near-infrared range in a light-emitting component.

U.S. Pat. No. 11,299,672 B2 describes specific phosphors, comprising garnet host lattices co-doped with Cr and Yb, and also components using them.

For many current and future applications of lighting devices that convert primary light into light with a wavelength in the range of more than 650 nm, however, the converting light-emitting diodes stated are not sufficient. In particular, they are unable to achieve the radiant emittance required.

In connection with the present invention, the radiant emittance indicates the magnitude of the output secondary luminous flux of the light-converting material, based on a defined surface area of the secondary light spot. Accordingly, for a constant level of the secondary luminous flux, the radiant emittance increases with a smaller surface area. Light-converting LEDs are limited here, as the excitation must be carried out with the divergent light beam of a diode, which leads to a comparatively large primary light spot and consequently also to a large secondary light spot.

Examples of these light-converting LEDs which emit in the near-infrared range are OSLON P 1616 SFH 4737 from AMS-Osram or LUXEON IR ONYX from Lumileds. For example, then, OSLON P1616 SFH 4737 comprises a blue LED as an excitation light source, which has an area of around 2.6 mm² and a specified irradiance of not more than 74 mW in the wavelength range from 600 to 1050 nm. This means that the specific emission is at most 0.03 W/mm². LUXEON IR ONYX likewise comprises a blue LED as a primary light source, which has an area of around 2.4 mm² and a specified irradiance of not more than 72 mW in the wavelength range from 600 to 1050 nm. This means that the specific emission is likewise at most 0.03 W/mm².

Furthermore, the cooling of the light-converting material is difficult in the case of the typically transmissive LEDs, in which primary and secondary light spots are located on opposite sides of the light-converting material. In contrast, when using solid-ceramic converter materials, the excitation can take place with a laser as a light source, which firstly has a higher power and secondly can be focused on a point or a small area. In particular, it is also possible for primary and secondary light spots to be located on the same side of the light-converting material, so that can be effectively cooled via the opposite side. This means that a significantly smaller primary light spot with higher irradiance can be achieved, possibly leading to a smaller secondary light spot and thus to an increase in the radiant emittance.

However, the use of a high-power excitation light source such as a laser poses further difficulties, especially with regard to the conversion efficiency of the light-converting material. Conversion efficiency, then, is influenced firstly by the Stokes efficiency and secondly by the quantum efficiency. Stokes efficiency describes the energy yield of a photon when converted from a smaller to a larger wavelength, releasing energy losses in the form of heat. The greater the difference between the wavelength of the primary light source and the wavelength of the emitted secondary light, the greater the losses here become. When using a blue laser as an excitation light source, this wavelength difference is naturally comparatively large in lighting devices that are intended to emit red or NIR light, and accordingly the energy losses are large. However, the resulting heat negatively influences the quantum efficiency, which for many materials converting to NIR light is significantly less than 100%.

What is needed in the art is a way to provide a light conversion unit, in particular for a lighting device, which emits secondary light with a wavelength in the far-red and NIR range and which in particular has a high specific emission or a high spectral power density.

### SUMMARY OF THE INVENTION

In some embodiments provided according to the invention, a lighting device includes a light source for emitting primary light, which is configured as a laser; and a light conversion unit including a light conversion element having at least one light-converting ceramic material, a front side, and a back side, a substrate which is directly or indirectly connected to the back side of the light conversion element, and a connector between the light conversion element and the substrate. The light conversion element is adapted to be illuminated with the primary light and to emit secondary light with a wavelength or wavelength range altered relative to the primary light. The primary light has a wavelength of less than 650 nm and the secondary light has a maximum intensity of emission at a wavelength of more than 650 nm.

In some embodiments provided according to the invention, a light conversion unit includes a light conversion element having at least one light-converting ceramic material, a front side, and a back side, a substrate which is directly or indirectly connected to the back side of the light conversion element, and a connector between the light conversion element and the substrate. The light conversion element is adapted to be illuminated with primary light and to emit secondary light with a wavelength or wavelength range altered relative to the primary light. The primary light has a wavelength of less than 650 nm and the secondary light has a maximum intensity of emission at a wavelength of more than 650 nm.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic sectional representation of a lighting device, together with a detector for measuring the diffusely emitted converted radiation;

FIG. 2 shows the structure of an embodiment of the light conversion unit provided according to the invention in cross section;

FIG. 3 shows the emission spectrum of the light-converting ceramic material according to Example 1;

FIG. 4 shows the numerical simulation (radiative flux [W] or the radiant emittance [W/mm²] at increasing irradiance [W/mm²]) for a ceramic converter;

FIG. 5, shows the emission spectra of the light-converting ceramic material according to Example 2;

FIG. 6 shows the emission spectra of the light-converting ceramic material according to Example 3; and

FIG. 7 shows the emission spectra of the light-converting ceramic material according to Example 4.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

In a first aspect of the invention, a lighting device is provided that comprises a light source for emitting primary light which is configured as a laser, and a light conversion unit, comprising a light conversion element comprising at least one light-converting ceramic material, wherein the light conversion element has a front side and a back side, wherein the light conversion element is adapted to be illuminated with the primary light and to emit secondary light with a wavelength or wavelength range altered relative to the primary light, a substrate which is directly or indirectly connected to the back side of the light conversion element, and a connector between the light conversion element and the substrate, wherein the primary light has a wavelength of less than 650 nm and the secondary light has a maximum intensity of emission at a wavelength of more than 650 nm.

In a second aspect, the invention relates to a light conversion unit comprising a light conversion element, comprising at least one light-converting ceramic material, wherein the light conversion element has a front side and a back side, wherein the light conversion element is adapted to be illuminated with the primary light and to emit secondary light with a wavelength or wavelength range altered relative to the primary light, a substrate which is directly or indirectly connected to the back side of the light conversion element, and a connector between the light conversion element and the substrate, wherein the primary light has a wavelength of less than 650 nm and the secondary light has a maximum intensity of emission at a wavelength of more than 650 nm.

It has been found that the lighting device provided according to the invention or the light conversion unit provided according to the invention allows a high irradiance on a small primary light spot and thus has a high radiant emittance from a small secondary light spot.

Where, below, explanations and descriptions and also exemplary embodiments with regard to the light conversion unit in the lighting device provided according to the invention are given, these shall also be valid correspondingly for the light conversion unit provided according to the invention, as far as they are applicable.

According to the invention, the lighting device comprises a light source for emitting primary light and a light conversion unit comprising a light conversion element which is designed to be illuminated with the primary light and to emit secondary light with a wavelength or wavelength range altered relative to the primary light.

According to the invention, the light source is configured for emitting primary light as a laser, wherein the primary light has a wavelength of less than 650 nm. Optionally, the primary light has a wavelength in the range from 400 nm to 530 nm, optionally in the range from 420 nm to 500 nm, optionally from 440 nm to 465 nm and, for example, 450 nm.

The light conversion element is adapted to be illuminated with the primary light and to emit secondary light. The secondary light has at least one altered wavelength or wavelength range relative to the primary light.

On illumination with the primary light, in particular with the wavelength in the range from 400 nm to 530 nm, optionally in the range from 420 nm to 500 nm, optionally from 440 nm to 465 nm and, for example, 450 nm, secondary light is emitted from the light conversion element, with the secondary light having a maximum intensity of emission at a wavelength of more than 650 nm.

The maximum emission is therefore in the red or NIR wavelength range.

Optionally, the secondary light has a maximum intensity of emission at a wavelength in the range from 650 nm to 1700 nm, optionally from 650 nm to 1100 nm.

Optionally, the light conversion element in the wavelength range from 650 nm to 1700 nm has a radiant emittance of at least 0.1 W/mm², optionally at least 0.5 W/mm², optionally at least 1.0 W/mm² or at least 1.5 W/mm².

Optionally, the specified radiant emittance refers to the radiant emittance at a primary light spot size with a diameter of 0.5 mm and an excitation irradiance of at least 0.2 W/mm², optionally at least 0.5 W/mm², optionally at least 1 W/mm². The excitation irradiance does not mean that the lighting device is operated with the specified irradiance, but merely specifies the irradiance with which the specified radiant emittance is determined. The same applies to the specification of the primary light spot size.

Optionally, the irradiance of the primary light, the so-called excitation irradiance, is at least 10 W/mm², optionally at least 20 W/mm², optionally at least 40 W/mm².

Optionally, the primary light spot has a diameter of not more than 1.5 mm, optionally not more than 1 mm, optionally not more than 0.5 mm.

Optionally, the secondary light comprises a wavelength range of at least 50 nm, optionally at least 75 nm, optionally at least 100 nm, wherein the wavelength range of the secondary light encompasses emissions with an intensity of at least 10% of the maximum intensity of emission.

This wavelength range represents the range from the smallest wavelength at which there is an emission with an intensity of at least 10% of the maximum intensity to the largest wavelength at which the emission is at least 10% of the maximum intensity. In some exemplary embodiments, the stated wavelength range comprehensively comprises emissions with an intensity of at least 10% of the maximum intensity of emission.

The secondary light which the light conversion element is able to emit when irradiated with the primary light can be detected experimentally. For the determination of the wavelength range of the secondary light, the light conversion element can be excited with the primary light, in particular with the wavelength in the range from 400 nm to 530 nm, optionally in the range from 420 nm to 500 nm, optionally from 440 nm to 465 nm and, for example, 450 nm, and the light emitted can be measured spectrally by means of a spectrometer.

For the determination of the wavelength range from a spectrum measurable in this way, use is made in particular only of the part of the measured spectrum beyond a wavelength of more than the wavelength of the primary light, in particular beyond 465 nm. In particular, therefore, within the scope of this invention, the spectrum by which the secondary light is characterized is to be understood as the spectrum beyond a wavelength of 465 nm. With this definition of the emission spectrum, it is also possible advantageously during measurement to avoid including diffusely reflected primary light in the secondary light, as will be further detailed later on below.

According to the invention, the light conversion unit comprises a light conversion element comprising a front side and a back side, which is adapted to be illuminated on its front side with primary light and to emit secondary light with a wavelength altered relative to the primary light on its front side and/or its back side, optionally on its front side.

The light conversion element has a thickness t extending from the front side to the rear side, wherein the thickness t is in the range from 50 μm to 250 μm, optionally from 70 μm to 225 μm, optionally from 80 μm to 200 μm or from 80 μm to 150 μm.

The light conversion element comprises or consists of at least one light-converting ceramic material. Optionally, the light conversion element is a solid, sintered, polycrystalline material comprising or consisting of at least one, optionally one, light-converting ceramic material, wherein the light conversion element may subsequently also be referred to as “ceramic converter” or “optoceramic”. In some embodiments, the light conversion element comprises a mixture of two or more light-converting ceramic materials.

In some embodiments, the light conversion element further comprises at least one further ceramic non-light-converting material, hereinafter also called “further ceramic material”, wherein the at least one further ceramic material has a higher thermal conductivity than the at least one light-converting ceramic material. Optionally, the at least one further ceramic material is Al₂O₃, Y₂O₃, YAlO₃, MgO, AlN, and/or SiN, optionally Al₂O₃.

Optionally, the at least one light-converting ceramic material comprises one or more oxides, one or more nitrides and/or one or more oxynitrides, or consists thereof.

Optionally, the light conversion element comprises at least one light-converting ceramic material of the general formula

$${( {A}_{1 - x} {L}_{x} )}_{3} {( {B}_{1 - y} {M}_{y} )}_{5} {O}_{12} ,$$

for which:
A is one or more selected from Y, Lu and Gd
L is one or more selected from lanthanoids and Sc, optionally selected from Yb, Nd, Er,
Ce and Sc, optionally Ce
B is one or more selected from Al and Ga
M is one or more selected from Cr and Mn
x <0.2, optionally <0.1
y <0.2, optionally <0.1,
with x+y>0, or consists thereof.

Optionally, 0<x+y<0.2, optionally less than 0.1, optionally less than 0.07.

In some embodiments, x is less than 0.15, optionally less than 0.1, optionally less than 0.07, optionally less than 0.05, optionally less than 0.03.

In some embodiments, y is less than 0.15, optionally less than 0.1, optionally less than 0.07, optionally less than 0.05, optionally less than 0.03.

In some embodiments, x<y.

In some embodiments, x=0.

Optionally, the at least one light-converting ceramic material is selected from Y₃(Al_{1-y}Cr_{y})₅O₁₂, (Y₁₋ₓCeₓ)₃(Al_{1-y}CR_{y})₅O₁₂, (Y₁₋ₓ(Nd, Ce)ₓ)₃Al₅O₁₂, Gd₃(Ga_{1-y}Cr_{y})₅O₁₂ and (Gd₁₋ₓCeₓ)₃(Ga_{1-y}Cr_{y})₅O₁₂.

Optionally, the light conversion element comprises scattering centers, wherein the scattering centers optionally comprise pores or other light-scattering inclusions or particles, optionally pores.

Optionally, the light conversion element has a scattering coefficient s of 10 cm⁻¹ to 1000 cm⁻¹, optionally of 150 cm⁻¹ to 850 cm⁻¹, optionally of 250 to 600 cm⁻¹ at 600 nm.

The degree of optical scattering, described by the scattering coefficient s, influences (together with the absorption coefficient) in particular how large the proportion of converted backscattered, in particular blue, excitation radiation is, and also how far the excitation radiation diffuses within the light conversion element until complete absorption, and also how far the converted light diffuses within the light conversion element until it leaves the light conversion element again as useful light. Important indicators such as the efficiency of a component or the emission light spot size are influenced by the scattering. For remissive (irradiation and emission on the same side) lighting devices, a sufficiently large optical scattering coefficient is desired.

Optionally, the light conversion element comprises a multiplicity of pores, which optionally have a median of the diameters of 0.1 μm to 2 μm.

The median of the diameters of the pores, in particular of the pores located in a cross section, is optionally between 0.1 μm and 2 μm, optionally between 0.3 μm and 1.5 μm, optionally between 0.4 μm and 1.2 μm.

The median divides a data set, or a sample or a distribution, in the present case for example the diameter of the pores in the cross section, into two equal parts such that the values, i.e. the pore diameters, are in the one half not greater than the median value and in the other not less.

Optionally, the light conversion element has a porosity in the range from 0.5% to 15%, optionally from 1% to 10%, optionally from 2% to 6%.

The porosity P of the light conversion element can be determined using the following formula:

$$P = 1 - \frac{ρ}{{ρ}_{th}}$$

wherein ρₜₕ is the theoretical density of the at least one ceramic material of the light conversion element and ρ is the measured porosity of the light conversion element.

Details on the determination of the porosity and of the median of the diameters of the pores can be taken, for example, from German Patent Application DE 10 2022 120 647 A.

Optionally, the substrate in the light conversion unit provided according to the invention is configured as a heat sink.

Optionally, the substrate comprises at least one ceramic, at least one metal or at least one ceramic-metal composite or consists thereof, optionally a metal, optionally Cu, Al, Fe or Ni, optionally Cu or Al, and/or has a thermal conductivity of greater than 30 W/mK, optionally greater than 100 W/mK, optionally greater than 150 W/mK, optionally greater than 350 W/mK.

Optionally, the substrate comprises Cu, in particular Ni—P— and/or Au-coated Cu, or consists thereof.

According to the invention, the light conversion unit comprises a connector which is located between the substrate and the light conversion element. Optionally, the connector is configured as at least one organic adhesive, at least one glass, at least one ceramic adhesive, at least one inorganic adhesive, at least one sintered sinter paste and/or at least one metallic solder connection, optionally as a metallic solder connection or a sintered sinter paste.

In some embodiments, the connector has a thermal conductivity of more than 10 W/mK, optionally more than 30 W/mK, optionally more than 50 W/mK or more than 100 W/mK.

In some embodiments, the connector is configured as a metallic solder or as a sintered sinter paste, wherein the solder optionally has a melting point below 300° C. and/or optionally comprises an Au/Sn solder and/or AuSn8020 or consists thereof.

The connector may also be configured as a sintered sinter paste, optionally as an Ag-containing sinter paste.

Optionally, the sintered sinter paste has a layer thickness of 1 μm to 50 μm, optionally from 5 μm to 40 μm, optionally from 10 μm to 30 μm, optionally from 15 μm to 25 μm.

Optionally, the sintered sinter paste has a thermal conductivity of at least 50 W/mK, optionally at least 100 W/mK, optionally of at least 150 W/mK.

In particular in embodiments in which the connector is a sintered sinter paste, it may be advantageous for the surface of the light conversion element and the surface of the substrate, which are connected to each other, to have a coating. Optionally, the light conversion element is provided with an Ag-containing thin-film layer, optionally additionally with an Au-containing thin-film layer, or coated with a Cu-containing thin-film layer or an Ag-containing thick-film layer. Exemplary embodiments of the Ag-containing thin-film layer and the Au-containing thin-film layer and the Ag-containing thick-film layer are described below and are valid here accordingly. In exemplary embodiments, the surface of the substrate has a coating, the coating optionally being an Au-containing coating and/or an NiP coating. Optionally, the surface of the substrate is provided with an NiP layer, wherein the NiP layer optionally has a layer thickness of 1 μm to 10 μm, optionally 3 μm to 7 μm and/or wherein the Au layer optionally has a layer thickness of 50 nm to 500 nm, optionally 100 nm to 400 nm, optionally 150 nm to 300 nm.

In embodiments in which the connector is a sintered sinter paste, the light conversion element and the substrate are connected according to the following steps:
a) providing a substrate and a light conversion element;
b) applying the sinter paste at least on a part of the surface of the substrate and/or at least on a part of the surface of the light conversion element;
c) contacting the surface of the substrate and the surface of the light conversion element, with at least a part of the surface of the substrate and/or at least a part of the surface of the light conversion element being covered with the sinter paste;
d) sintering the assembly obtained in step c).

In step a) of the process, a substrate and a light conversion element are provided. Optionally, the surfaces of the substrate and/or of the light conversion element have the coatings described in more detail above.

In step b), a sinter paste is applied at least on a part of the surface of the substrate and/or at least on a part of the surface of the light conversion element. Optionally, a sinter paste is applied at least on a part of the substrate. Typically, the amount of sinter paste is metered such that after the sintering step d), the sintered sinter paste has a layer thickness of 1 μm to 50 μm, optionally from 5 μm to 40 μm, optionally from 10 μm to 30 μm, optionally from 15 μm to 25 μm.

In step c), the surface of the substrate and the surface of the light conversion element, with at least a part of the surface of the substrate and/or at least a part of the surface of the light conversion element being covered with the sinter paste, are contacted with each other. Optionally, the surface of the light conversion element is contacted with a part of the surface of the substrate, with the part of the surface of the substrate being at least partly covered with sinter paste. The contacting can take place with application of pressure, optionally at least 15 mN/mm², optionally more than 30 mN/mm², optionally more than 60 mN/mm².

In step d), the assembly obtained in step d) is sintered. Sintering can take place under an oxygen-containing atmosphere or in air or under an inert gas atmosphere, in particular in an N2¬ or Ar atmosphere. Sintering takes place at temperatures in the range from 180° C. to 300° C.

Optionally, the sinter paste has a sintering temperature of not more than 300° C., optionally not more than 280° C., optionally not more than 250° C. Optionally, the sintering takes place by heating of the assembly to the desired sintering temperature, with heating optionally in a first step up to a first temperature, at optionally at least 0.5 K/min, optionally at least 0.75 K/min and/or at not more than 3 K/min, optionally not more than 2 K/min. Optionally, the first temperature is in the range from 70° C. to 120° C., optionally 80° C. to 105° C. Optionally, after reaching the first temperature, the temperature is held for 1 min to 60 min, optionally for 5 min to 45 min, optionally 20 min to 40 min. Optionally, in a second step, the assembly is subsequently heated up to a second temperature at optionally at least 1.0 K/min, optionally at least 1.5 K/min and/or not more than 3.5 K/min, optionally not more than 3 K/min. Optionally, the second temperature is in a range from 180° C. to 300° C., optionally 200° C. to 280° C., and corresponds to the sintering temperature. Optionally, after attainment of the second temperature, or the sintering temperature, the temperature is held at least 10 min, optionally at least 20 min or at least 30 min and/or not longer than 60 min, optionally not longer than 50 min or 40 min. The assembly is thereafter cooled to optionally room temperature.

In some embodiments, the light conversion unit has at least one highly reflective layer or coating, wherein the highly reflective layer or coating is optionally a metallic layer or coating and/or a dielectric layer or coating, optionally an Ag or Ag-containing layer or coating.

It may be the case, for example, that the light conversion element on its back side is given a reflection layer, in particular a metallic reflection layer, optionally comprising or composed of Ag, in particular such that the back side of the light conversion element is coated with the reflection layer, and wherein the reflection layer is optionally applied by vapor deposition, sputtering (thin-film layer) or printing (thick-film layer) on the back side of the light conversion element.

In some embodiments, the light conversion element has a reflection layer which is a thin-film layer. Optionally, the thin-film layer comprises Ag or consists thereof and/or has a layer thickness of 50 nm to 500 nm, optionally from 100 nm to 350 nm, optionally from 125 nm to 300 nm, optionally from 150 nm to 250 nm. In some embodiments, the light conversion element has a thin-film layer comprising or consisting of Ag and a further thin-film layer comprising or consisting of Au. Optionally, the further thin-film layer is applied by vapor deposition or sputtering. Optionally, the thin-film layer comprising or consisting of Au has a layer thickness of 50 nm to 500 nm, optionally from 100 nm to 350 nm, optionally from 125 nm to 300 nm, optionally 150 nm to 250 nm. The thin-film layer comprising or consisting of Au can serve to protect the reflection layer comprising or consisting of Ag from oxidation reactions, above all at higher temperatures, which can prevail for example when connecting the light conversion element to the substrate, for example with a sinter paste.

In some embodiments, the light conversion element has a reflection layer which is an Ag-containing thick-film layer. The thick-film layer optionally has a layer thickness of 1 μm to 25 μm, optionally 5 μm to 20 μm, optionally of 10 μm to 15 μm.

In some embodiments, the light conversion unit comprises at least one optical separation layer, which is optionally located between the at least one highly reflective layer and the back side of the light conversion element, wherein the at least one optical separation layer is optionally transparent and/or has a refractive index lower than the refractive index of the light conversion element, wherein the at least one optical separation layer optionally comprises SiO₂ or consists thereof, and wherein the optical separation layer optionally has a thickness of less than 5 μm, optionally in the range from 0.5 μm to 1.5 μm, optionally in the range from 0.8 μm to 1.2 μm.

The optical separation layer can be used to separate the reflection and, where appropriate, the total reflection of the secondary light reaching the back side of the light conversion element (converter back side) at the converter back side from the reflection of the portion of the secondary light traversing the converter back side at a highly reflective layer, in particular at a metallic mirror.

In some embodiments, the light conversion unit has at least one adhesion promoter layer, which is optionally located between the at least one highly reflective layer and the optical separation layer, optionally comprising or consisting of one or more oxides selected from the group consisting of TiO₂, Y₂O₃, La₂O₃ and SnO₂, optionally Y₂O₃. Optionally, the adhesion promoter layer has a thickness of 1 nm or more and/or less than 100 nm, optionally less than 75 nm, optionally of less than 50 nm, optionally less than 35 nm and optionally of less than 20 nm.

The above-described lighting device and light conversion unit can be used, for example, in the context of “dynamic” applications (color wheels) or optionally “static” applications (dies on heatsink).

In a further aspect, the invention relates to the use of the lighting device or the light conversion unit in infrared spectroscopy, in particular for use in medicine, forensics or chemistry, in infrared projection, in security monitoring, for example iris detection, or in smoke alarms, and/or in infrared illumination.

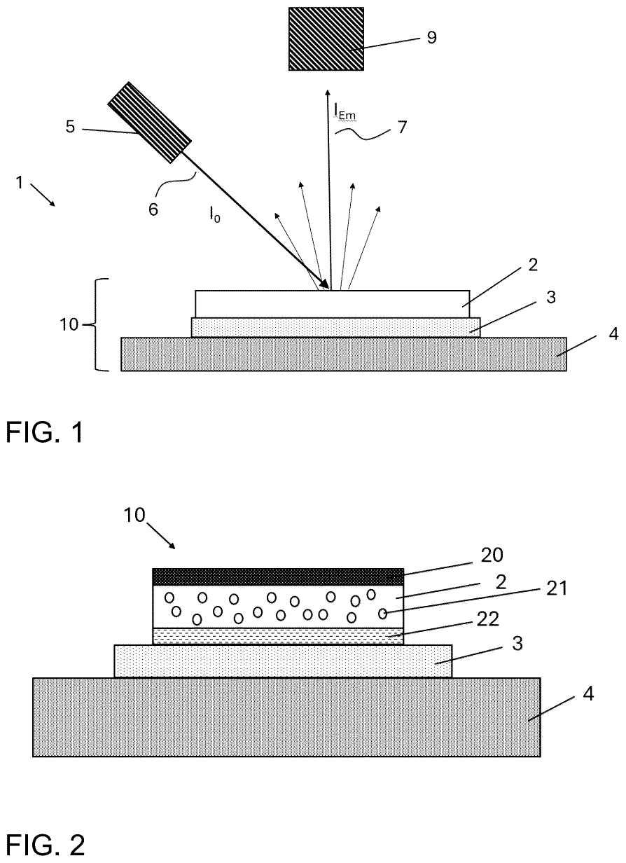

Referring now to the drawings, FIG. 1 shows a lighting device 1 including a measurement setup with detector 9, described in more detail below, which is not to be understood as part of the lighting device 1.

The lighting device 1 comprises a light conversion unit 10, in this case with a light conversion element 2, a connector 3, and a substrate 4 configured, for example, as a mirror, a primary light source 5, e.g. a blue laser beam source, in particular with beam shaping, which is adapted to emit a laser beam 6, which strikes the front side of the light conversion element 2, so that secondary radiation 7 in the form of diffusely emitted converted radiation is produced.

With the measurement setup shown, it is possible in particular to measure the emission spectrum and determine the efficiency from it. The detector 9 is a detector for the diffusely emitted converted radiation. Depending on the nature of the detector 9, the diffusely emitted converted radiation can be determined quantitatively, for example with a spectrometer, and/or qualitatively, for example with a spectrophotometer.

According to one example, for instance, a double-sidedly polished converter material of defined thickness can be placed on a mirror with a reflectivity in the visible spectrum of more than 95%. Excitation can be by blue light with a wavelength of 448-455 nm. The emitted light can then be measured spectrally using a spectrometer. For the determination of the wavelength or the wavelength range of the emitted light from the spectrum, in particular the range beyond a wavelength of 465 nm can be used.

The emission spectrum can therefore be regarded in particular as the emitted spectrum beyond a wavelength of 465 nm. In particular, this definition can ensure that specularly or diffusely reflected excitation light does not enter into the emission spectrum.

The irradiation with intensity I₀ takes place in particular obliquely, so that with a second detector, not shown, the specularly reflected Fresnel radiation (not shown) with intensity I_{Fre} can be measured. The irradiated intensity I₀ is also known, via a separate measurement. With the test setup, the intensity of the emission spectrum I_{Em} (beyond 465 nm) can be measured by a detector 9. The efficiency n is then calculated according to η=I_{Em}/(I₀−I_{Fre}).

The light conversion element 2 may be configured in particular as a ceramic converter. The connector 3 is optionally configured as a solder, adhesive or sintered sinter paste. The substrate 4 may be configured, for example, as a heat sink, i.e. a cooling element, optionally comprising or consisting of copper.

FIG. 2 shows an embodiment, provided according to the invention, of the light conversion unit 10 with a light conversion element 2, a substrate 4 and a connector 3. The light conversion element 2 may be configured in particular as a ceramic converter, optionally as a ceramic converter comprising pores 21. Optionally, an anti-reflective coating 20 is applied on the front side of the light conversion element 2, and optionally comprises one or more laminas. Optionally, a back-side coating 22 is applied on the back side of the light conversion element 2. The connector may be configured, for example, as a solder, adhesive, or sintered sinter paste. The substrate may be configured, for example, as a heat sink, e.g. comprising or consisting of copper, or as a “wheel” comprising or consisting of aluminium. The back-side coating 22 may comprise one or more coatings, in particular a highly reflective coating and optionally an optical separation layer and/or an adhesion promoter layer.

### EXAMPLES

Although the present invention has been described with reference to exemplary working examples, it is not limited thereto, and is modifiable in various ways.

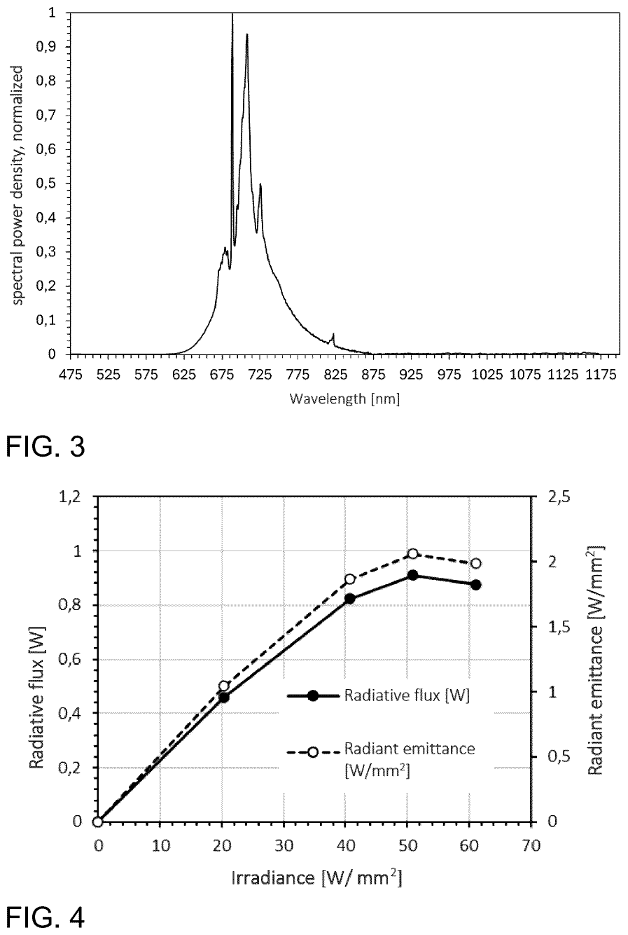

Examples 1 to 4 provided according to the invention were produced according to the methods described below and emission spectra were measured, which are shown in FIGS. 3, 5, 6, and 7. All examples produced have a porosity of 4.5% and a scattering coefficient s of 400 cm⁻¹ at 600 nm. The median of the diameters of the pores of Examples 1, 2, and 3 is 0.7 μm, the median of the diameters of the pores of Example 4 is 0.8 μm.

To measure the emission spectrum, the double-sidedly polished wafers or wafer rings of defined thickness were placed on a mirror having a reflectivity in the visible spectrum of more than 95%. Excitation is by blue laser light at 50 mW with a wavelength of 450 nm. The light emitted was measured spectrally by a spectrophotometer. The measurement was performed at room temperature.

### Example 1—YAG:Cr

Powders of the pure oxides yttrium oxide, aluminium oxide and chromium oxide were mixed according to the composition of the desired compound Y₃ (Al_{0.99}Cr_{0.01})₅O₁₂ and after addition of ethanol, dispersants and pressing aids, were admixed with grinding balls and finely ground in a barrel using a roller bed. The slurry was thereafter dried by a rotary evaporator and then uniaxially pressed into cylindrical green bodies. The green bodies were debound at around 600° C., followed by the reactive sintering in air at around 1600° C. for several hours. The sintered bodies were sawn into wafers and then ground and polished to a thickness of 200 μm.

FIG. 3 shows the emission spectrum of Y₃(Al_{0.99}Cr_{0.01})₅O₁₂ (YAG:Cr) according to Example 1. The normalized spectral power density ([1/(mm²×nm)] is plotted against the wavelength [nm]. The emission spectrum shows that the secondary light encompasses an entire wavelength range from around 620 nm to around 850 nm with maximum intensity at 690 nm (characteristic Cr emission bands). The breadth of the wavelength range in which the emissions of secondary light consistently exhibit at least 10% of the maximum intensity is around 110 nm.

FIG. 4 shows the numerical simulation (radiative flux [W] or the radiant emittance [W/mm²] with increasing irradiance [W/mm²]) for a ceramic converter according to Example 1 with a thickness of 80 μm on a copper heat sink of format 20×20×4 mm, mounted on a heat exchanger with a temperature of 30° C., which is irradiated with a blue laser (450 nm). The circular laser spot (primary light spot) has a diameter of 0.5 mm and has a top hat profile. The diameter of the emission spot (secondary light spot) is 0.75 mm. At an irradiance of around 50 W/mm, radiative flux or radiant emittance reaches its maximum, the so-called irradiance limit. The reason for this is the temperature-dependent quantum efficiency (“thermal quenching”). The increasing warming of the material with increasing irradiance causes the quantum efficiency to drop continuously, which drives the warming further, until the decrease in quantum efficiency can finally no longer be compensated by further increase in the radiative flux.

Numerical simulations were carried out in principle as described in V. Hagemann, A. Seidl, G. Weidmann: Static ceramic phosphor assemblies for high power high luminance SSL-light sources for digital projection and specialty lighting. Proc. of SPIE Vol. 11302 113021N-11, SPIE OPTO, San Francisco 2020, hereinafter [1].

In principle it should be mentioned that the light conversion properties (the level of the emitted luminous power or the emitted luminous flux, the irradiance limit) essentially depend on the following properties of the converter material and other boundary conditions:
Characteristics of the incident blue laser beam:
   wavelength, power, power density, beam profile.
Characteristics of the converter material:
   absorption coefficient and scattering coefficient for the incident blue laser radiation and for the converted
   radiation of greater wavelength, quantum efficiency, Stokes shift, refractive index,
   thermal conductivity and thickness. These properties (except thickness t) are more or less temperature-dependent.
Characteristics of the converter surfaces or interfaces:
   reflectivity of the incidence side and emission side (front side)
   reflectivity of the back side, heat transfer at the back side to an actively or passively cooled wheel (“dynamic” case) or to an actively or passively cooled heat sink (“static” case), and also the surface quality of the converter ceramic (usually polished).

### Example 2—YAG:Ce,Cr

The pure oxides yttrium oxide, aluminium oxide, cerium oxide and chromium oxide were used according to the composition of the desired compound (Y_{0.9964}Ce_{0.0036})₃(Al_{0.99}Cr_{0.01})₅O₁₂. The production of the sample was similar to the method described in Example 1.

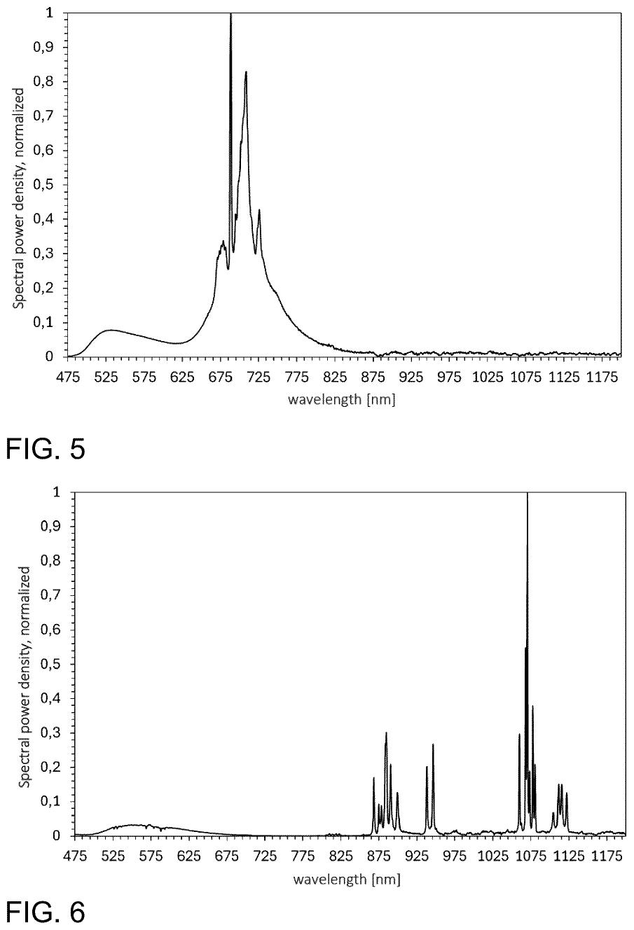

FIG. 5 shows the emission spectrum of (Y_{0.9964}Ce_{0.0036})₃(Al_{0.99}Cr_{0.01})₅O₁₂ (YAG:Ce,Cr). The normalized spectral power density ([1/(mm²×nm)] is plotted against the wavelength [nm]. The emission spectrum shows that the secondary light encompasses a wavelength range from around 480 nm to around 850 nm, with maximum intensity at 690 nm (characteristic Cr emission bands). The measured emission in the range from around 480 to around 620 nm shows the characteristic Ce emission, where, however, the Ce in the present example serves to increase the Cr emission by “charge transfer”. The breadth of the wavelength range in which the emissions of secondary light consistently exhibit at least 10% of the maximum intensity is around 120 nm.

### Example 3: YAG:Ce,Nd

The pure oxides yttrium oxide, aluminium oxide, cerium oxide and neodymium oxide were used according to the composition of the desired compound (Y_{0.965}Nd_{0.02}Ce_{0.015})₃Al₅O₁₂.

The production of the sample was similar to the method described in Example 1.

FIG. 6 shows the emission spectrum of (Y_{0.965}Nd_{0.02}Ce_{0.015})₃Al₅O₁₂ (YAG:Ce,Nd). The normalized spectral power density ([1/(mm²×nm)] is plotted against the wavelength [nm]. The emission spectrum shows that the secondary light encompasses a wavelength range of around 480-1120 nm, with the characteristic emission bands of the Nd between around 850 and around 1120 nm, most strongly between 1050 and 1100 nm, with a maximum at 1070 nm. The measured emission in the range from around 480 to around 700 nm shows the characteristic Ce emission, where, however, the Ce in the present example serves to enable the Nd emission by “charge transfer”. The breadth of the wavelength range in which the emissions of secondary light exhibit at least 10% of the maximum intensity is around 260 nm.

### Example 4—GGG:Cr

The pure oxides gadolinium oxide, gallium oxide and chromium oxide are used according to the composition of the desired compound Gd₃(Ga_{0.99}Cr_{0.01})₅O₁₂. The production of the sample is similar to the method described in Example 1.

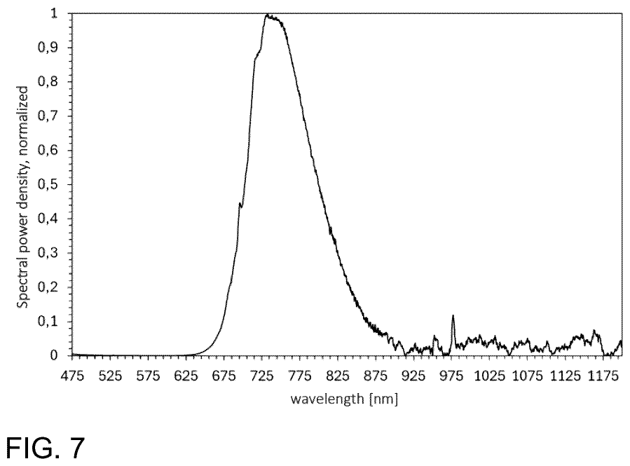

FIG. 7 shows the emission spectrum of Gd₃(Ga_{0.99}Cr_{0.01})₅O₁₂ (GGG:Cr). Counts are plotted against the wavelength [nm]. The emission spectrum shows that the secondary light encompasses a wavelength range from around 640 nm to around 920 nm, with maximum intensity at 730 nm (characteristic Cr emission bands). The breadth of the wavelength range in which the emissions of secondary light consistently exhibit at least 10% of the maximum intensity is around 200 nm.

The following table summarizes the properties of Examples 1 to 4 provided according to the invention:

| | | | Wavelength | Breadth of | Maximum | |
|---|---|---|---|---|---|---|
| | | Maximum of | range of | wavelength | radiant | |
| | Conversion | secondary | secondary | range | emittance | Irradiance |
| Ex. | efficiency | light [nm] | light [nm] | [nm] | [W/mm²] | [W/mm²] |
| 1 | 12% | 690 | 620-850 | 110 | 2.1 | 50 |
| 2 | 28% | 690 | 620-850 | 120 | 2.3 | 50 |
| 3 | 10% | 1070 | 850-1120 | (single lines) | 0.7 | 40 |
| 4 | 12% | 730 | 640-920 | 200 | 1.5 | 50 |

The conversion efficiency [W/W] specified in the table above is determined by the ratio of the converted emitted power Iₑₘ [W] to the excitation power of the laser I₀ [W] at room temperature. The power of the laser is known and is around 1 mW; the converted emitted power can be obtained by a quantitative evaluation of the emission spectrum in the region of the secondary light. For this purpose, the wavelength range of the secondary light specified in the table above was taken into account.

The maximum specified in the table above refers to the wavelength [nm] at which the secondary light has a maximum intensity, determined from the emission spectra described above.

The stated breadth of the wavelength range of the secondary light in the table above refers to the region of the emission spectrum in which the spectral power density is—where appropriate consistently—at least 10% of the maximum spectral power density.

The radiant emittance in the table above refers to the maximum radiant emittance [W/mm²] for a laser spot corresponding to the primary light spot with a top hat profile and a diameter of 0.5 mm. For this purpose, the wavelength range of the secondary light specified in the table above was taken into account.

The irradiance in the table above indicates the irradiance [W/mm²] at which the maximum radiant emittance was achieved (the “irradiance limit”). The irradiance limit was determined for Examples 1 to 4 as described in connection with FIG. 5.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

1 lighting device
2 light conversion element
3 connector
4 substrate
5 primary light source
6 laser beam
7 secondary radiation
9 detector
10 light conversion unit
20 anti-reflective coating
21 pores
22 back-side coating

What is claimed is:

1. A lighting device, comprising:
a light source for emitting primary light, which is configured as a laser; and
a light conversion unit comprising a light conversion element comprising at least one light-converting ceramic material, a front side, and a back side, a substrate which is directly or indirectly connected to the back side of the light conversion element, and a connector between the light conversion element and the substrate, wherein the light conversion element is adapted to be illuminated with the primary light and to emit secondary light with a wavelength or wavelength range altered relative to the primary light, wherein the primary light has a wavelength of less than 650 nm and the secondary light has a maximum intensity of emission at a wavelength of more than 650 nm.

2. The lighting device of claim 1, wherein the primary light has a wavelength in a range from 400 nm to 530 nm.

3. The lighting device of claim 1, wherein the secondary light has a maximum intensity of emission at a wavelength in a range from 650 nm to 1700 nm and/or the secondary light encompasses a wavelength range of at least 50 nm, wherein the wavelength range of the secondary light encompasses emissions with an intensity of at least 10% of the maximum intensity of emission.

4. The lighting device of claim 1, wherein the light conversion element has a thickness extending from the front side to the back side and the thickness is between 50 μm and 250 μm.

5. The lighting device of claim 1, wherein the at least one light-converting ceramic material comprises one or more oxides, one or more nitrides, and/or one or more oxynitrides.

6. The lighting device of claim 1, wherein the light conversion element comprises at least one further ceramic material, wherein the at least one further ceramic material has a higher thermal conductivity than the at least one light-converting ceramic material.

7. The lighting device of claim 1, wherein the light conversion element comprises at least one light-converting ceramic material of the general formula (A₁₋ₓLₓ)₃(B_{1-y}M_{y})₅O₁₂, wherein:
A is one or more selected from Y, Lu and Gd;
L is one or more selected from lanthanoids and Sc;
B is one or more selected from Al and Ga;
M is one or more selected from Cr and Mn;
$$x < 0.2 ;$$
$$y < 0.2 ; and$$
$$x + y > 0.$$

8. The lighting device of claim 7, wherein the at least one light-converting ceramic material is selected from the group consisting of Y₃(Al_{1-y}Cr_{y})₅O₁₂, (Y₁₋ₓCeₓ)₃(Al_{1-y}CR_{y})₅O₁₂, (Y₁₋ₓ(Nd, Ce)ₓ)₃Al₅O₁₂, Gd₃(Ga_{1-y}Cr_{y})₅O₁₂, and (Gd₁₋ₓCeₓ)₃(Ga_{1-y}Cr_{y})₅O₁₂.

9. The lighting device of claim 1, wherein the light conversion element contains scattering centers.

10. The lighting device of claim 1, wherein the light conversion element has a scattering coefficient s of 10 cm⁻¹ to 1000 cm⁻¹.

11. The lighting device of claim 1, wherein the light conversion element comprises a multiplicity of pores.

12. The lighting device of claim 1, wherein the light conversion element has a porosity in a range from 0.5% to 15%.

13. The lighting device of claim 1, wherein the substrate is configured as a heat sink.

14. The lighting device of claim 1, wherein the substrate comprises at least one ceramic, at least one metal, or at least one ceramic-metal composite and/or has a thermal conductivity of greater than 30 W/mK.

15. The lighting device of claim 1, wherein the light conversion element is adapted to be illuminated on its front side with the primary light and to emit the secondary light on its front side.

16. The lighting device of claim 1, wherein the light conversion element in a wavelength range from 650 nm to 1700 nm has a radiant emittance of at least 0.1 W/mm².

17. The lighting device of claim 1, wherein the light conversion unit has at least one highly reflective layer or coating.

18. The lighting device of claim 1, wherein the light conversion unit comprises at least one optical separation layer.

19. The lighting device of claim 1, wherein the light conversion unit has at least one adhesion promoter layer.

20. The lighting device of claim 1, wherein the connector is configured as at least one organic adhesive, at least one glass, at least one ceramic adhesive, at least one inorganic adhesive, at least one sintered sinter paste, and/or at least one metallic solder connection.

21. A light conversion unit, comprising:
a light conversion element comprising at least one light-converting ceramic material, a front side, and a back side, a substrate which is directly or indirectly connected to the back side of the light conversion element, and a connector between the light conversion element and the substrate, wherein the light conversion element is adapted to be illuminated with primary light and to emit secondary light with a wavelength or wavelength range altered relative to the primary light, wherein the primary light has a wavelength of less than 650 nm and the secondary light has a maximum intensity of emission at a wavelength of more than 650 nm.
